(19) United States
(12) Patent Application Publication
(10) Pub. No.: US 2019/0050822 A1
(43) Pub. Date: Feb. 14, 2019

(54) METHOD AND SYSTEM FOR MAINTAINING A MEASURING POINT IN A PLANT OF PROCESS AUTOMATION

(71) Applicants: Endress+Hauser Process Solutions AG, Reinach (CH); ENDRESS+HAUSER MANAGEMENT AG, Reinach (CH); ENDRESS+HAUSER GMBH+CO. KG, Maulburg (DE); ENDRESS+HAUSER INFOSERVE GMBH+CO. KG, Weil am Rhein (DE); ENDRESS+HAUSER MESSTECHNIK GMBH+CO. KG, Weil am Rhein (DE)

(72) Inventors: Marc Baret, Kembs (FR); Georg Hauss, Freiburg (DE); Ulrich Kaiser, Basel (CH); Michael Maneval, Schopfheim (DE); Markus Nick, Kembs (FR)

(21) Appl. No.: 15/756,188

(22) PCT Filed: Aug. 12, 2016
(86) PCT No.: PCT/EP2016/069195

§ 371 Date: Jun. 6, 2018

(30) Foreign Application Priority Data
Sep. 4, 2015 (DE) 10 2015 114 837.4

(51) Int. Cl. G06Q 10/00; G05B 19/418; G06Q 50/04; G06F 17/30

(52) U.S. Cl. CPC G06Q 10/20; G05B 19/4187; G05B 19/41845; G06Q 50/04; G05B 2219/25428; G06F 17/30997; G05B 2219/24001; G05B 2219/25061; G06F 17/30991

(57) ABSTRACT

The invention relates to a method and to a system for maintaining a measuring point in a plant of process automation, comprising at least one plurality of field devices, which are located in a storage area, a database for storing a product type of each of the plurality of field devices and associated device features of the plurality of field devices, and a computing unit, in which a substitution matrix is implemented, and which can access the database and there read out, store and/or associate data, and which calculates a suitability evaluation for each of the plurality of field devices.

The invention relates to a method and to a system for maintaining a measuring point in a plant of process automation, which comprises at least one plurality of field devices, which are located in a storage area, a database and a computing unit.

Known from the state of the art are field devices, which are used in industrial plants. Field devices are often applied in automation technology, especially process automation and manufacturing automation technology. Referred to as field devices are, in principle, all devices, which are applied near to the process and which deliver, or process, process relevant information. Thus, field devices are used for registering and/or influencing process variables. Serving for registering process variables are measuring devices, e.g. sensors. These are used, for example, for pressure- and temperature measurement, conductivity measurement, pH measurement, flow measurement, fill level measurement, etc., and register the corresponding process variables, pressure, temperature, conductivity, pH-value, fill level, flow, etc. Used for influencing process variables are actuators. These are, for example, pumps or valves, which can influence the flow of a liquid in a pipe or the fill level in a container. Besides the above mentioned measuring devices and actuators, referred to as field devices are also remote I/Os, radio adapters, and, in general, devices, which are arranged at the field level.

A large number of such field devices are produced and sold by the Endress+Hauser group of companies.

Replacement field devices, which replace an outdated or defective field device at a measuring point in a plant, must be specifically suited for the particular application. However, an immense number of variants of a field device are possible. Even within a product type of field device, for example, the Proline Promag P200, a magneto inductive flow measuring device of the Endress+Hauser group, a large number of variations are possible, for example, as regards flange size, Ex-protection, measured medium, fieldbus protocol, etc.

If a field device of a plant fails, then a replacement must be secured immediately, in order, depending on the application of the field device, to avoid a possible process stoppage. Often, customers keep a large number of field devices in a storage area. For the customers, it is, in given cases, however, difficult to select a suitable replacement device from those available in the storage area. Also, because of the many variants of the field devices, it is unlikely that a customer will have in the storage area a field device exactly suitable for the particular application.

An object of the invention, thus, is to provide a method and a system permitting, in simple manner, selection of a suitable replacement field device for a plant.

The object is achieved by a method for maintaining a measuring point in a plant of process automation, comprising steps as follows:
registering a product type of each of a plurality of field devices, wherein the field devices are located in a storage area, and storing the product types in a database;
collecting device features of the plurality of field devices, wherein the device features comprise a discrete representation of performance characteristics of each of the plurality of field devices, and associating the device features with their product types stored in the database;
collecting the product type and the device features of a field device to be replaced at the measuring point;
comparing the product type and the device features of the field device to be replaced with the product types stored in the database and the associated device features;
calculating a suitability evaluation based on a substitution matrix for each of the plurality of field devices, wherein the suitability evaluation represents a degree of agreement of the device features and wherein the substitution matrix represents a rule for mutual substitution of various device features; and
publishing the suitability evaluations for a customer, wherein the customer selects a replacement field device from the plurality of field devices based on suitability evaluation, wherein a higher suitability evaluation represents a higher degree of agreement of the device features.

An advantage of the method of the invention is that it significantly eases a customer's selecting from a storage area a replacement field device suitable for a measuring point. Even when the device features of the field devices differ, the logic of the substitution matrix provides the opportunity for selecting a replacement field device with device features differing from the device features of the field device to be replaced. The substitution matrix represents, in such case, a logical algorithm.

In order to be able to select a replacement field device having device features differing from the device features of the field device to be replaced, the device features of the replacement field device must be able to be substituted for those of the field device to be replaced. For example, an option is to replace a field device to be replaced, which has the device feature “not Ex-certified”, with a replacement field device, which has the device feature “Ex-certified”. This is, however, not possible in the reverse direction.

Thus, rapid maintenance by an immediate replacement of the field device is possible. In order to accelerate start-up of the replacement field device, a last stored parameter set of the previous field device can be stored in the replacement field device. Proviso for this, however, is data set compatibility of the replacement field device with the previous field device.

In an advantageous, further development of the method of the invention, supplementally to the suitability evaluation, differences of the device features of the field device to be replaced compared with the device features of the field devices located in the storage area are displayed. In this way, a more knowledgeable decision of the customer concerning an exchange device is possible, since the suitability evaluation is made transparent, for example, when similar values of the suitability evaluation are calculated for a number of different potential replacement field devices. Also, the risk of a possible erroneous decision can be lessened thereby.

An especially preferred variant of the method of the invention provides that, supplementally, steps are performed as follows, in case none of the plurality of field devices has the same product type as the field device to be exchanged at the measuring point:
compiling a measuring point specification of the measuring point of the plant, wherein the measuring point specification is a specification of technical properties or a specification of performance characteristics or a description of permitted operating ranges;
translating the measuring point specification of the measuring point of the plant into required device features;
comparing the required device features with the associated device features stored in the database and calculating the suitability evaluation for each of the plurality of field devices; and
selecting by the customer of that one of the plurality of field devices, which has the highest suitability evaluation in the form of the highest degree of agreement of the device features.

An advantage of this variant of the method of the invention is that potential replacement field devices can be found, when no replacement field device with fitting product type is present in the storage area. For example, an option is to replace a magneto inductive flow measuring device with a flow measuring device of other type, provided the agreement of the device features is high enough.

Likewise possible is that the replacement field device selected by these variants represents an even better coordination to the requirements of the measuring point than the previously applied field device to be exchanged, since an optimizing of the work on the specification of the measuring point results from these variants and the translation of the measuring point specification into device features.

In an especially advantageous, further development of the method of the invention, the method steps as claimed in claim 1 and the method steps as claimed in dependent claim 3 are performed in parallel. An advantage of this variant of the method of the invention is that the number of possible replacement field devices in the storage area is increased.

Furthermore, the object is achieved by a system for maintaining a plant of process automation, which system is suitable for performing the method of the invention, comprising
a plurality of field devices, which are located in a storage area;
a database for storing a product type of each of the plurality of field devices and ordering codes of the plurality of field devices;
a computing unit, in which a substitution matrix is implemented and which can access the database and there read out, store and/or associate data and which calculates a suitability evaluation for each of the plurality of field devices.

A preferred embodiment of the system of the invention is that the database is reachable by means of cloud computing web services. The terminology, cloud computing, means, in this case, the storing of data in a remote computing center, in this case, in a remote database. An advantage is that a centralizing of the data occurs, since each field device stores its data in the form of device types and diagnosis reports in this database.

The invention will now be explained in greater detail based on the appended drawing, the sole FIGURE of which show as follows:

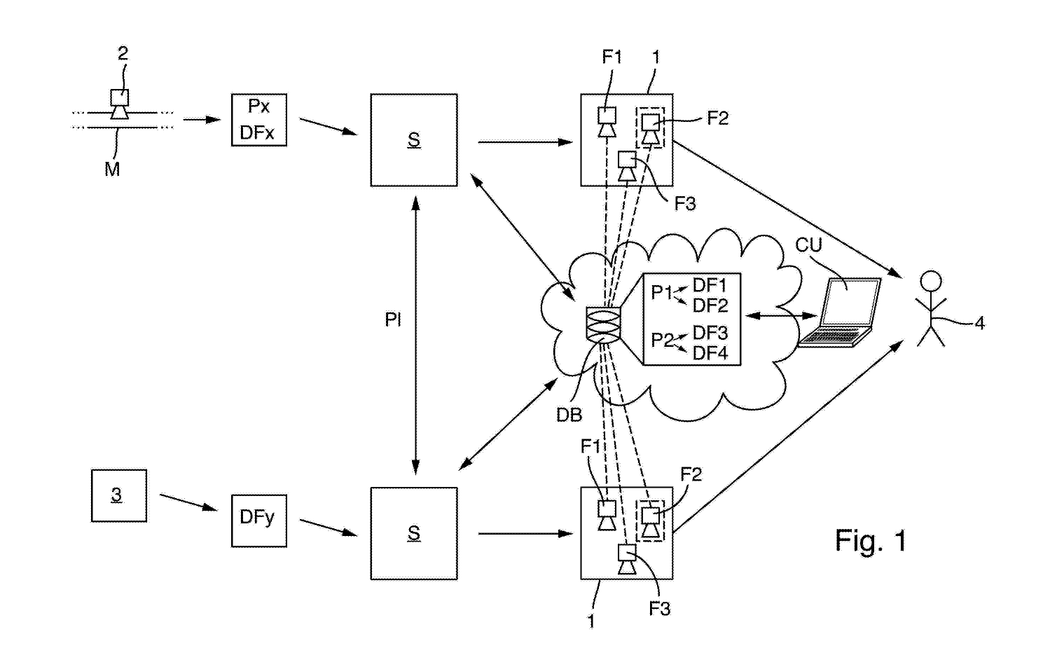

FIG. 1 an embodiment of the method of the invention for maintaining a measuring point in a plant of process automation.

FIG. 1 displays an embodiment of the method of the invention for maintaining a measuring point in a plant of process automation. Located at a measuring point M of a plant of process automation of a customer 4 is a field device 2, which is to be replaced because of a defect or age.

Located in a storage area 1 of the customer are a plurality of field devices F₁, F₂, F₃. In order to check suitability as a replacement field device in the case of each one of the plurality of field devices F₁, F₂, F₃, the product type P₁, P₂ and the device features DF₁, DF₂, DF₃, DF₄ of each of the plurality of field devices F₁, F₂, F₃ are registered. The registering can occur manually, in which case the customer 4 inputs the product types P₁, P₂ and the device features F₁, F₂, F₃ into a computing unit CU. Since an individual field device can have about 60-80 different device features DF₁, DF₂, DF₃, DF₄, the registration process can be complicated and tedious. Therefore, it is alternatively possible to provide ordering codes of the field devices F₁, F₂, F₃, which are automatically converted into the device features DF₁, DF₂, DF₃, DF₄.

The following presents an example of an ordering code, “Profibus PA”, of one of the plurality of field devices F₁, F₂, F₃, more exactly a pressure difference measuring device, with device features DF₁, DF₂, DF₃, DF₄ converted therefrom:

| | |
|---|---|
| ordering code | Profibus PA |

| | | |
|---|---|---|
| device features | DF₁: parametering | −>remote servicing via |
| | software | FieldCare |
| | DF₂: electrical | −>screw terminals |
| | connection | |
| | DF₃: type of supply | −>two-conductor |
| | DF₄: protocol type | −>Profibus PA |

“Profibus PA” is, in such case, the ordering code for the communication. Other field devices F₁, F₂, F₃ located in the storage area can, in given cases, have other ordering codes for communication, for example, according to a fieldbus protocol, HART, Foundation Fieldbus, etc., and, as a result, have different device features.

The registered product types P₁, P₂ of the plurality of field devices F₁, F₂, F₃. and the registered/converted device features DF₁, DF₂, DF₃, DF₄ are associated with one another and stored in a database DB. The database (DB) is reachable by means of cloud computing web services.

Furthermore, the product type Pₓ of the field device to be replaced and its device features DFₓ are registered.

Then, with a search method S, a search for a replacement field device of the plurality of field devices F₁, F₂, F₃ is begun. For this, first, the product type Pₓ of the field device 2 to be replaced is compared with the product types P₁, P₂ of the plurality of field devices F₁, F₂, F₃. Then, the device features DFₓ are compared with the device features DF₁, DF₂, DF₃, DF₄ of the plurality of field devices F₁, F₂, F₃. A logic algorithm in the form of a substitution matrix creates a suitability evaluation for each of the plurality of field devices F₁, F₂, F₃. A suitability evaluation displays a degree of agreement of device features between the field device 2 to be replaced and a potential replacement field device of the plurality of field devices F₁, F₂, F₃. The greater the agreement of the device features DF₁, DF₂, DF₃, DF₄, DFₓ, the higher is the suitability evaluation.

In order to be able to select a replacement field device F₁, F₂, F₃, which differs in the device features DFₓ compared to the device features DF₁, DF₂, DF₃, DF₄ of the field device 2 to be replaced, the device features DFₓ of the replacement field device F₁, F₂, F₃ must be able to substitute for those of the field device 2 to be replaced. For example, an option is to replace a field device 2 to be replaced, which has as device feature DF₁, DF₂, DF₃, DF₄ “not Ex-certified”, with a replacement field device, which has as device feature DF₁, DF₂, DF₃, DF₄ “Ex-certified”. On the other hand, this is not possible in the reverse direction. In the above example of the pressure difference device, for example, a replacement of the device feature DF₂, “electrical connection”, is possible, while a replacement of the device feature DF₄ “protocol type” is not possible. The substitution matrix has at all times the necessary information, in order to be able to provide a unique statement concerning a substitution possibility of a device feature DF₁, DF₂, DF₃, DF₄. For example, the substitution matrix can make use of a database with possible substitutions. Preferably, this database is regularly updated with the newest information.

After calculating the suitability evaluation for each of the plurality of field devices F₁, F₂, F₃, these suitability evaluations are provided to the customer, wherein it is suggested to the customer 4 to select one of the field devices F₁, F₂, F₃ with the highest suitability evaluation. Moreover, the customer can be shown the differences between the device features DFₓ of the field device 2 to be replaced and the device features DF₁, DF₂, DF₃, DF₄ of the field devices F₁, F₂, F₃ located in the storage area 1, whereby the customer can make a more knowing decision for a replacement field device F₁, F₂, F₃. In this example of an embodiment, the replacement field device is field device F₂.

In case none of the plurality of field devices F₁, F₂, F₃ are of the same product type P₁, P₂ as the field device 2 to be exchanged at the measuring point M, a measuring point specification 3 of the measuring point M of the plant is compiled, wherein the measuring point specification 3 is a specification of technical properties or a specification of performance characteristics or a description of permitted operating ranges. The measuring point specification 3 of the measuring point M of the plant is then translated into required device features DF_{y}. Thereupon, such as above described, a search method S is begun for a replacement field device from the plurality of field devices F₁, F₂, F₃. For this, also here, suitability evaluations are created for each of the plurality of field devices F₁, F₂, F₃, wherein it is suggested to the customer 4 that one of the field devices F₁, F₂, F₃ with the highest suitability evaluation be selected. In this example of an embodiment, this is field device F₂.

An advantage of this variant of the method of the invention is that potential replacement field devices can be found from the plurality of field devices F₁, F₂, F₃, when no replacement field device of the plurality of field devices F₁, F₂, F₃ with fitting product type is in the storage area. For example, an option is to replace a magneto inductive flow measuring device with a flow measuring device of some other type, when the agreement of the device features DF₁, DF₂, DF₃, DF₄, DF_{y} is high enough

In an additional variation, the customer 4 can perform the two described methods in parallel mode PL, whereby the customer obtains an essentially higher selection possibility for a replacement field device from the plurality of field devices F₁, F₂, F₃.

### LIST OF REFERENCE CHARACTERS

DB database
DF₁, DF₂, DF₃, DF₄ device features of the field devices of storage area
DFₓ device features of the field device to be replaced
DF_{y} device features of the measuring point specification
P₁, P₂ product types of the field devices of storage area
Pₓ product type of the field device to be replaced
PL parallel method execution
CU computing unit
S search method
F₁, F₂, F₃ plurality of field devices
1 storage area
2 field device to be replaced
3 measuring point specification
4 customer

1-6. (canceled)

7. A method for maintaining a measuring point in a plant of process automation, comprising:
registering a product type of each of a plurality of field devices located in a storage area and storing the plurality of product types in a database;
collecting device features of each of the plurality of field devices, the device features including a discrete representation of performance characteristics of each of the plurality of field devices, and associating the device features with the product type of the respective field device stored in the database;
collecting a product type and device features of a field device to be replaced at the measuring point;
comparing the product type and the device features of the field device to be replaced with the product types stored in the database and the device features associated with each product type;
calculating a suitability evaluation for each of the plurality of field devices, wherein the suitability evaluation represents a degree of agreement of the device features of the respective field device with the device features of the field device to be replaced, and wherein the suitability evaluation is based on a substitution matrix representing rules for mutual substitution of various device features;
publishing the suitability evaluation for each of the plurality of field devices; and
selecting a replacement field device from the plurality of field devices based on the suitability evaluations, wherein a higher suitability evaluation represents a higher degree of agreement of the device features.

8. The method as claimed in claim 7, further comprising:
displaying differences of the device features of the field device to be replaced with the device features of each of the plurality of field devices.

9. The method as claimed claim 7, further comprising:
when none of the plurality of field devices has the same product type as the field device to be replaced:
compiling a measuring point specification of the measuring point, the measuring point specification including a specification of technical properties, a specification of performance characteristics, or a description of permitted operating ranges;
translating the measuring point specification into required device features;
comparing the required device features with the associated device features of each of the plurality of field devices stored in the database and calculating a suitability evaluation for each of the plurality of field devices; and
selecting from the plurality of field devices the field device having the highest suitability evaluation in the form of the highest degree of agreement of the device features with the required device features.

10. The method as claimed in claim 9, wherein the method steps of registering the product type, collecting the device features, collecting the product type, comparing, calculating, and publishing and the method steps of compiling a measuring point specification, translating, and comparing are performed in parallel.

11. A system for maintaining a measuring point in a plant of process automation, which system is suitable for performing the method as claimed in one of claims 1 to 4, comprising
a plurality of field devices located in a storage area;
a database configured to store a product type of each of the plurality of field devices and associated device features of each of the plurality of field devices;
a substitution matrix including rules for mutual substitution of various device features;
a computing unit in which the substitution matrix is implemented and which can access the database including reading out data, storing data, and/or associating data, the computing unit configured to calculate a suitability evaluation for each of the plurality of field devices.

12. The system as claimed in claim 11, wherein the database is reachable by means of cloud computing web services.
